(19) United States
(12) Patent Application Publication
(10) Pub. No.: US 2015/0300509 A1
(43) Pub. Date: Oct. 22, 2015

(54) Floating Ball Valve

(71) Applicant: Zenghua He, Shanghai (CN)

(72) Inventor: Zenghua He, Shanghai (CN)

(21) Appl. No.: 14/451,884

(22) Filed: Aug. 5, 2014

(30) Foreign Application Priority Data
Apr. 22, 2014 (CN) 201410163376.4

(51) Int. Cl. F16K 5/20; F16K 5/06

(52) U.S. Cl. CPC F16K 5/201; F16K 5/06

(57) ABSTRACT

The present invention discloses a floating ball valve, which includes a valve body, a ball, (2) valve seats on both inlet and outlet ends, and a valve stem. The valve body includes a valve body cavity therein, the ball and the valve seats are both assembled in the valve body cavity, and the valve stem and the ball are connected and assembled in the valve body, the valve seats are connected to the valve body through elastic elements; and when the floating ball valve is closed, the ball of the floating ball valve and the valve seats both move inside the valve body cavity.

### CROSS-REFERENCE TO RELATED APPLICATIONS

The present application claims priority under 35 U.S.C. §119 to Chinese patent application 201410163376.4, filed Apr. 22, 2014, the disclosure of which is incorporated herein by reference.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND

The present application claims priority under 35 U.S.C. §119 to Chinese patent application 201410163376.4, filed Apr. 29, 2014, the disclosure of which is incorporated herein by reference.

### TECHNICAL FIELD

The present invention relates to a valve used for fluid control, and in particular, to a floating ball valve.

### RELATED ART

A ball valve is a valve of which an opening and closing member (a ball) is driven by a valve stem and rotates by 90 degrees about an axis of the valve stem, and the ball valve is mainly used for adjustment and control of fluid flow. Ever since the birth of the ball valve, the ball valve is broadly applied to industries such as petroleum refining, long-distance transport pipelines, chemical industry, papermaking, pharmacy, water conservancy, electricity, municipal administration, and iron and steel industry, and is an indispensable part in the field of machinery.

The ball valve is mainly characterized in that the ball value has a compact and simple structure, has reliable sealing, and is convenient in maintenance. A sealing surface and a spherical surface are generally in a closed state under a medium's pressure, and thus the ball valve is not easily washed out or eroded by the medium; the ball valve is easy for operation and maintenance, is applicable to a common working medium such as water, solution, acid and natural gas, and is further applicable to a medium with poor working condition, such as oxygen, hydrogen peroxide, methane and ethylene. Therefore, the ball valve is widely applied in various industries. The valve body of the ball valve may be one piece formed as a whole or may be several separate pieces in a combined form.

In the current industry, the ball valve may be classified into a floating ball valve and a trunnion ball valve. The floating ball valve refers to that a ball inside the ball valve is floating (movable), and the floating ball may generate a certain displacement under a medium pressure to press against a sealing surface towards an outlet end, so as to ensure the sealing effect at the outlet end. Greater pressure results in better sealing performance, but a torque (force) used for opening and closing increases along with the increase of the pressure. The floating ball valve has a simple structure and a good sealing performance, but working pressure of the fluid medium born by the ball is completely transferred to the valve seat, and therefore, it should be taken into consideration whether the valve seats on either end can withstand the working pressure of the fluid medium; when being pressed by a relatively high pressure, soft material of the valve seats might offset, thereby causing reduction of sealing effect. Therefore, this structure is generally good to use in a scenario with a medium-low pressure and a small size valve.

Compared with the floating ball valve, a ball of the trunnion ball valve is not floating or movable, and valve seats thereof are movable. During operations, a force applied by a fluid pressure from an inlet of the valve on the ball is completely transferred to a valve stem, so that the ball does not move towards the valve seats, and thus, the valve seats do not receive an over-large pressure. As a result, the trunnion ball valve has a relatively smaller torque, a smaller valve seat deformation, a stable sealing performance, and a longer service life. Therefore, such structure is applicable to a scenario with a high pressure and a large size valve. On the other hand, generally speaking, to fix the ball position, the trunnion ball valve has a more complicated structure, and has a more complicate manufacturing process as compared with the floating ball valve.

Compared with the trunnion ball valve, the floating ball valve has a simpler manufacturing process and a lower cost; however, all pressure is born by the valve seats, so that a drive force required for opening and closing the floating ball valve is fairly large. On the other hand, floating ball valve seats in the prior art have all soft materials, and mostly made of Teflon, for example, in patent No. CN201020182464.6. When a medium pressure is increased, a pressure transferred by a ball to a valve seat is increased as well, which increases wear of the valve seat and thereby reducing sealing performance.

In view of the above, a new floating ball valve capable of overcoming the above defects is required in the prior art.

### SUMMARIZED DESCRIPTION

In order to overcome the defects in the prior art, the present invention provides a floating ball valve in which both a ball and valve seats are floating.

To achieve the object of the present invention, the present invention discloses a floating ball valve, which includes a valve body, a ball, (2) valve seats on both inlet and outlet ends, and a valve stem. The valve body includes a valve body cavity, where the ball and the valve seats are both assembled in. The valve stem and the ball are connected and assembled in the valve body, where the valve seats are connected to the valve body both inlet and outlet ends through multiple elastic elements; and when the floating ball valve is closed, the ball of the floating ball valve and the valve seats both move or float inside the valve body cavity.

Further, the elastic elements are coil springs. One end of the coil springs is connected behind the valve seat, and the other end of the coil springs is connected to the valve body.

Further, the valve seat base is made of a rigid material, such as metal and ceramic. The valve seat includes a seal ring, and the valve seat is connected to the ball through the seal ring. A surface of the valve seat facing the ball includes a first groove, and the first groove is used to embed the seal ring. A surface of the valve seat outer edge, facing the valve body includes a second groove, and the second groove is used to embed a second seal ring. The second seal ring can be an O-shaped seal ring or a V-shaped seal ring.

Further, a gap is formed between the valve seat and one end of the valve body. A movable distance for the ball in the valve body cavity is greater than the gap.

Compared with the prior art, the floating ball valve provided in the present invention designs the ball and the valve seats to be both floating for the first time, and uses the elastic elements to connect between the valve seat back side and the valve body. In this way, the following advantages can be implemented:

Firstly, the working pressure under the medium is spread to multiple parts, the floating ball valve can be used in a pipeline in a larger size and in an environment with a higher pressure; secondly, because both the ball and the valve seats are floating, the valve seats do not need to be moved away in advance before opening the floating ball valve, a low torque can be achieved by only self-adjusting positions of the ball and the valve seats. Therefore, the floating ball valve can be easily opened; thirdly, the valve seat is made of a rigid material, and the working pressure is spread to multiple different parts, so that such floating ball valve has a longer service life and a more stable structure; and fourthly, the valve seats and the ball provided in the present invention can be used in severe environments with greatly changed temperatures, pressures, and so on.

### BRIEF DESCRIPTION OF THE DRAWINGS

Advantages and spirit of the present invention may be further understood through detailed description of the present invention and accompanying drawings as follows:

FIG. 1 is a schematic structural view of a floating ball valve according to the prior art; and

FIG. 2 is a schematic view of a floating ball valve according to the present invention.

### DETAILED DESCRIPTION

Valve seats and a floating ball valve in a specific embodiment of the present invention are described in detail with reference to the accompanying drawings. However, it should be understood that, the present invention is not limited to the described embodiment, and technical ideas of the present invention can be implemented in combination with other well-known technologies or other technologies having functions the same as those of the well-known technologies.

In the following description, in order to clearly show the structure and working manner of the present invention, many directional terms are used; however, it should be understood that, those words such as “front”, “back”, “left”, “right”, “inner”, “outer”, “outwards”, “inwards”, “axial”, and “radial” are only used for ease of illustration instead of limiting the present invention.

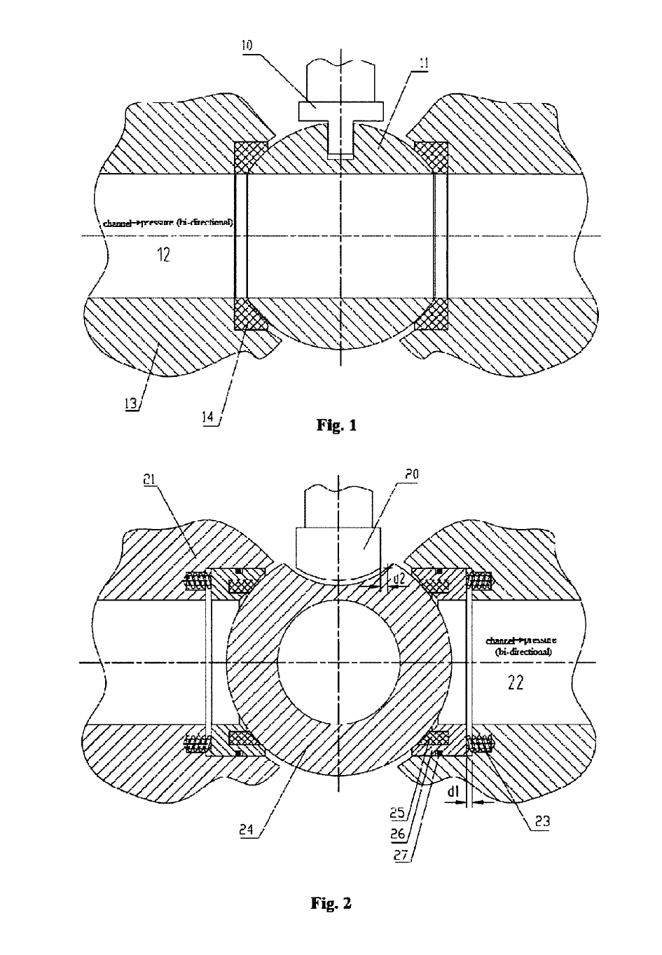

FIG. 1 shows an open state of a floating ball valve in the prior art, where 10 represents a valve stem, 11 represents a ball, 12 represents a media channel, 13 represents a valve body, and 14 represents one of the valve seats. In the prior art, the (2) valve seats 14 used in the floating ball valve must be made of a plastic material; otherwise, sealing effect cannot be achieved in a closed state of the floating ball valve. In the open state of the floating ball valve, a medium flows through the medium channel 12 and the ball 11. In the prior art, when the ball valve is opened from a closed state, it is hoping to minimize the torque of the valve stem as much as possible, and therefore, reducing the drive force required for opening, reducing the wear of the valve seat, and avoiding the reduction of sealing performance. In order to reduce the opening torque when rotating the valve stem, a friction between the valve seat and the ball must be as small as possible.

FIG. 2 is a schematic structural view of valve seats used in a floating ball valve according to the present invention. The floating ball valve shown in FIG. 2 is in a closed state. A valve body forms a valve body cavity, and the ball and the (2) valve seats are all assembled in the valve body cavity. When the floating ball valve is opened, the valve body cavity is filled with a medium, and the medium flows through a ball 24 and a channel 22. In the present invention, the ball 24 and valve seats 26 may both move in the valve body cavity, and therefore, after the medium enters the valve, the floating ball 24 is sealed with the movable valve seats 26 under the pressure of the medium in the ball cavity. Because the valve seats 26 are connected to the valve body through elastic elements 23, when the pressure born by the valve seats 26 are increased, the elastic elements 23 absorb a part of the pressure. A gap d1 is formed between one of the valve seats 26 and the valve body 21. When the pressure generated by the medium in the channel 22 gradually increases, the ball 24 is pushed to move. A movable range d2 of the ball in the channel is greater than the movable range d1 of the valve seat. When one of the valve seats 26 moves to a limit, the valve seat 26 presses tightly against the valve body 21 and the elastic elements 23 at the same time, and therefore, the pressure between the ball and the valve seats is spread to three different components including the valve seats, the elastic elements, and the valve body. The pressure distribution in the cavity is also changed. Therefore, compared with the prior art, the ball valve having the ball and the valve seats both floating provided in the present invention is more suitable for an environment with a larger size and a higher pressure.

In the floating ball valve provided in the present invention, when the valve stem 20 starts rotating, because of the friction between the valve seats 26 and the ball 24, springs 23 is pressed automatically to deform, and the springs absorb the friction through deformation; therefore, the torque during opening is greatly minimized. In the prior art, the valve seats cannot move and bear all the medium pressure, the friction is obviously large, so that the wear of the valve seats is increased after multiple times of opening and closing.

In the prior art, the valve seats used in the floating ball valve must be made of a plastic material; otherwise, sealing effect cannot be achieved. In the present invention, the valve seats 26 are also floating in the valve body cavity along with the floating ball, so that the valve seats in the present invention are made of a rigid material such as metal and ceramic, and the contact surface between the valve seats and the ball is covered by a plastic material which has smaller friction coefficient on the sealing surface. In this way, the service life of the valve seats is enhanced, but the frictional pressure is not increased, thereby reducing the risk of poor sealing effect due to damage of the valve seats. In another preferred embodiment, to achieve an optimal sealing effect, a groove is formed in a surface of the valve seats 26 facing the ball, and the groove 25 is used to embed a seal component made of a plastic material. In this way, when the ball 24 contacts the valve seats 26, the medium will not flow between the ball and the valve seats because of the existence of the plastic seal component, and because the plastic seal component has a small deformation under the pressure, the plastic material on the sealing surface of the valve seats is not severely damaged after the ball is tightly pressed against the valve seats 26. Moreover, another groove 27 is further formed in an surface of the valve seat outer edge 26 connected to the valve body 21, so as to embed a seal ring of an O shape, a V shape, or other shapes. Compared with the prior art, the floating ball valve provided in the present invention can be applied to an environment with dramatically changed temperatures and pressures, this is because when low temperature occurs, different materials of the ball valve have different thermal expansivity, and due to cold contraction and deformation, the floating ball and the floating valve seats adjust the pressure mutually; therefore, no manual intervention is required, and good sealing effect is achieved automatically. When the pressure increases, the pressure is spread out to multiple different parts, thereby avoiding deformation of a single part due to overload.

What are described in the specification are preferred embodiments of the present invention, and the embodiments are only used for describing the technical solution of the present invention instead of limiting the present invention. Technical solutions that can be made by professionals skilled in the art according to the present invention through logic analysis, ratiocination or limited experiment should all fall within the scope of the present invention.

We claim:

1. A floating ball valve, comprising:
a valve body, a ball, and a valve seat on an inlet end, wherein the valve body comprises
a valve body cavity, in which the ball and the valve seat are both assembled;
a valve stem, wherein said valve stem and the ball are connected and assembled in the valve body, and the valve seats are connected to the valve body through elastic elements;
and, when the floating ball valve is closed, the ball and the valve seats both move in the valve body cavity.

2. The floating ball valve according to claim 1, wherein the elastic elements comprise multiple coil springs, one end of the coil springs is connected behind the valve seat, and a second end of the coil springs is connected to the valve body.

3. The floating ball valve according to claim 1, wherein the valve seat is made of a rigid material.

4. The floating ball valve according to claim 1, wherein the valve seat is made of metal or ceramic.

5. The floating ball valve according to claim 1, wherein the valve seat comprises a seal ring, and the valve seat is connected to the ball through the seal ring.

6. The floating ball valve according to claim 1, wherein a surface of the valve seat facing the ball comprises a first groove, and the first groove is used to embed a seal ring through which the each valve seat is connected to the ball.

7. The floating ball valve according to claim 1, wherein a surface of the rigid valve seat outer edge facing the valve body comprises a second groove, and the second groove is used to embed a second seal ring.

8. The floating ball valve according to claim 7, wherein the second seal ring is an O-shaped seal ring or a V-shaped seal ring.

9. The floating ball valve according to claim 1, wherein a gap is formed between the valve seat and the valve body.

10. The floating ball valve according to claim 1, wherein a gap is formed between the valve seat and the valve body, and a movable distance for the ball in the valve body cavity is greater than the gap.

11. A floating ball valve, comprising:
a valve body, a ball, a first valve seat on an inlet end and a second valve seat on a outlet end, wherein the valve body comprises a valve body cavity, in which the ball and the valve seats are both assembled;
a valve stem, wherein said valve stem and the ball are connected and assembled in the valve body, and the valve seats are connected to the valve body through elastic elements;
and, when the floating ball valve is closed, the ball and the valve seats both move in the valve body cavity.

12. The floating ball valve according to claim 11, wherein the elastic elements comprise multiple coil springs, one end of the coil springs is connected behind the valve seat, and a second end of the coil springs is connected to the valve body.

13. The floating ball valve according to claim 11, wherein the valve seats are made of a rigid material.

14. The floating ball valve according to claim 11, wherein the valve seats are made of metal or ceramic.

15. The floating ball valve according to claim 11, wherein each of the valve seats comprises a seal ring, and each of said valve seats is connected to the ball through the seal ring.

16. The floating ball valve according to claim 11, wherein a surface of the valve seat facing the ball comprises a first groove, and the first groove is used to embed a seal ring through which the each valve seat is connected to the ball.

17. The floating ball valve according to claim 11, wherein a surface of the rigid valve seat outer edge facing the valve body comprises a second groove, and the second groove is used to embed a second seal ring.

18. The floating ball valve according to claim 17, wherein the second seal ring is an O-shaped seal ring or a V-shaped seal ring.

19. The floating ball valve according to claim 11, wherein a gap is formed between the valve seat and the valve body.

20. The floating ball valve according to claim 11, wherein a gap is formed between the valve seat and the valve body, and a movable distance for the ball in the valve body cavity is greater than the gap.
